(19) United States
(12) Patent Application Publication
(10) Pub. No.: US 2004/0089465 A1
(43) Pub. Date: May 13, 2004

(54) Pressure plate for switch or receptacle

(75) Inventors: Edward Brant, Burlington, NC (US); John F. Myers, Liverpool, NY (US); Gerald R. Savicki JR., Syracuse, NY (US)

Correspondence Address: Daniel P. Malley, Suite 400, 101 South Salina Street, Syracuse, NY, 13202, US

(73) Assignee: Pass & Seymour, Inc.

(21) Appl. No.: 10/697,194

(22) Filed: Oct. 30, 2003

Related U.S. Application Data
(63) Continuation of application No. 09/897,319, filed on Jun. 29, 2001, now Pat. No. 6,683,251.

(51) Int. Cl. H01H 9/02

(52) U.S. Cl. 174/53

(57) ABSTRACT

A pressure plate for an electrical device includes at least one internal standoff, at least one outboard standoff, and an anti-rotation leg. The internal and outboard standoffs prevent overtightening of the terminal screw. The anti-rotation leg preserves the orientation of the pressure plate and prevents a speed wire arm from being deformed when removing a speed wired wire from the device.

### CROSS-REFERENCE TO RELATED APPLICATIONS

This is a continuation application of U.S. patent application Serial No. 09/897,319, filed Jun. 29, 2001, now allowed, the entirety of which is incorporated herein by reference.

### FIELD OF THE INVENTION

This invention relates generally to the field of pressure plates used in electrical devices, and more particularly to a pressure plate which improves wire retention with a variety of wiring methods.

### BACKGROUND OF THE INVENTION

Electrical device manufacturers are challenged with trying to offer several wiring methods to an installer of switches and receptacles while at the same time trying to maintain a small device. Hot, neutral, and ground conductors are affixed to an electrical device using one of three methods: side wiring, back wiring, and speed wiring. In side wiring, the bare end of the conductor is wrapped a half turn around a terminal screw post and the screw head is tightened, trapping the conductor between the screw head and the terminal. The conductor must be wrapped in a clockwise direction so that tightening the screw doesn't unwrap the conductor from the screw post. Back wiring is similar to side wiring except that a pressure plate is positioned between the screw head and the terminal. The bare end of the conductor is trapped between the pressure plate and the terminal as the screw is tightened. In speed wiring, the bare end of the conductor is inserted into a hole of the body of the switch or receptacle, where the conductor is captivated by a terminal spring arm.

Problems occur when trying to devise a pressure plate which accommodates all three types of wiring on a narrow body device.

### SUMMARY OF THE INVENTION

Briefly stated, a pressure plate for an electrical device includes at least one internal standoff, at least one outboard standoff, and an anti-rotation leg. The internal and outboard standoffs prevent overtightening of the terminal screw. The anti-rotation leg preserves the orientation of the pressure plate and prevents a speed wire arm from being deformed when removing a speed wired wire from the device.

According to an embodiment of the invention, a pressure plate for an electrical device includes a flat portion, the flat portion having a hole centered therein; a first internal standoff adjacent the hole; an outboard standoff disposed at a first location on the flat portion; and an anti-rotation leg disposed at a second location on the flat portion.

### BRIEF DESCRIPTION OF THE DRAWINGS

FIG. 1A shows a cross-sectional view of an electrical device.

FIG. 1B shows an enlarged view of a portion of FIG. 1A.

FIG. 2A shows a pressure plate according to an embodiment of the invention.

FIG. 2B shows a pressure plate according to an embodiment of the invention.

FIG. 3 shows a partial cross-sectional view of the electrical device showing the speed wiring portions of the electrical device.

FIG. 4A shows the electrical device wired using back wiring.

FIG. 4B shows the electrical device wired using side wiring.

FIG. 4C shows the electrical device wired using speed wiring.

### DETAILED DESCRIPTION OF THE PREFERRED EMBODIMENT

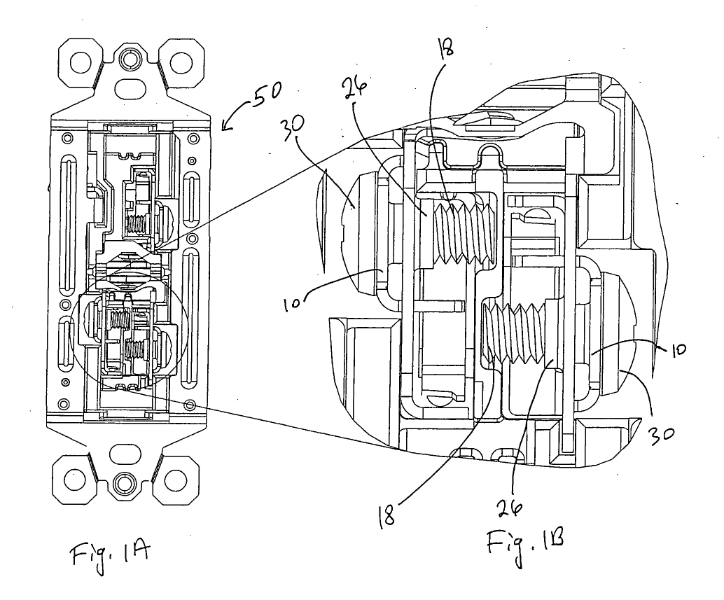

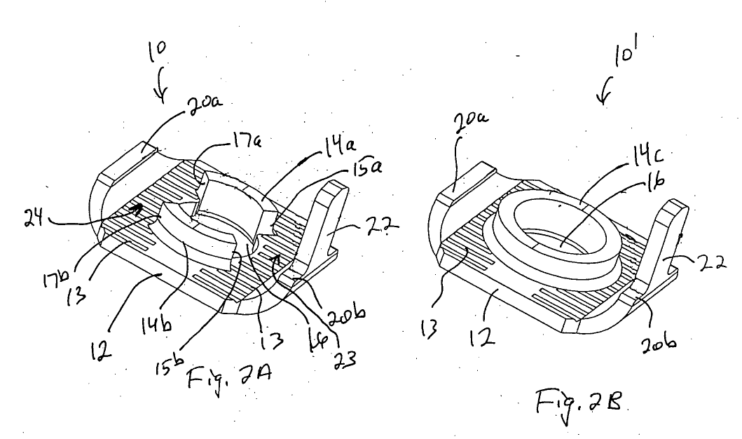

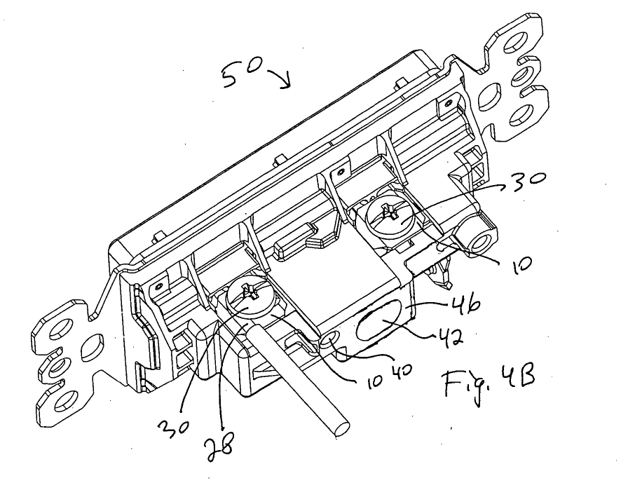

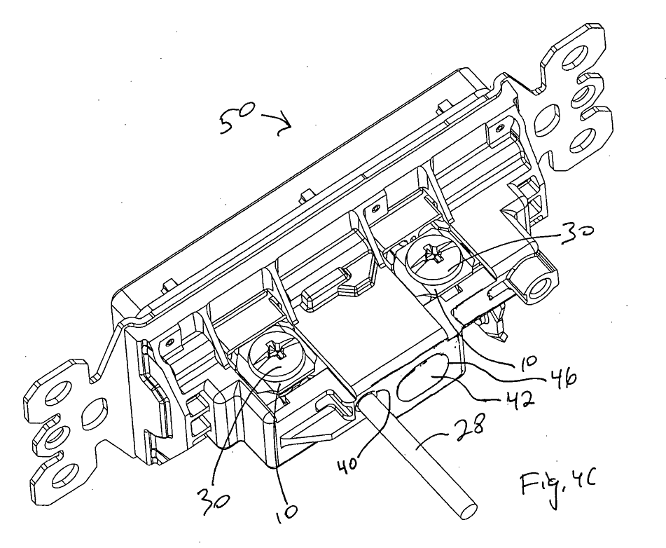

Referring to FIGS. 1A-1B, a portion of an electrical device 50 such as a switch or receptacle is shown. A terminal post screw 18 screws into a terminal post 26 to captivate a conductor wire 28 (FIG. 4A) between a pressure plate 10 and a screw head 30 as shown in FIGS. 4A and 4B.

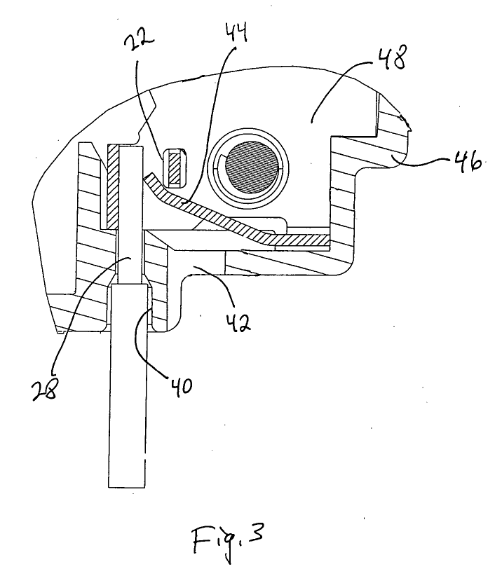

Referring also to FIG. 2A, pressure plate 10 includes a preferably square or rectangular captivation portion 12 so as to fit within the conventional structure for a device terminal. A plurality of shallow grooves 13 aid in gripping the conductor wire. Inboard standoffs 14a, 14b are preferably on opposite sides of a hole 16 for terminal post screw 18. Outboard standoffs 20a, 20b are preferably on opposite sides of captivation portion 12.

Inboard standoffs 14a, 14b are preferably opposing arcuate sections, with opposing ends 15a, 15b of inboard standoffs 14a, 14b together with outboard standoff 20b defining a passageway 23 for wire 28 on one side of hole 16 and opposing ends 17a, 17b of inboard standoffs 14a, 14b together with outboard standoff 20a defining a passageway 24 for wire 28 on the other side of hole 16.

The height for inboard standoffs 14a, 14b must be equal to or greater than the height for outboard standoffs 20a, 20b, with the preferable height for inboard standoffs 14a, 14b is equal to the height of outboard standoffs 20a, 20b. An anti-rotation leg 22 further extends from outboard standoff 20b.

Referring to FIG. 2B, an embodiment is shown for a pressure plate 10′ in which the two inboard standoffs 14a, 14b are replaced by a single inboard standoff 14c. This embodiment is easier to manufacture than the embodiment of FIG. 2A, but does not provide for passageways to facilitate back wiring.

FIG. 4A shows back wiring, FIG. 4B shows side wiring, and FIG. 4C shows speed wiring.

Inboard standoffs 14a, 14b have three functions. The first function is wire alignment/captivation in that the conductor wire is aligned by one of passageways 23 and 24 which are formed on one side by part of internal standoffs 14a, 14b.

The second function is to prevent screw 18 from interfering with screws of opposite terminals when the terminal post screw 18 is fully tightened. This interference becomes a concern with a narrow body device as shown in FIG. 1B, where it can be seen that, in the absence of internal standoffs 14a, 14b, over-tightening one screw 18 can cause that screw 18 to penetrate too far into device 50 and make contact with the terminal on the other side.

The third function is to prevent terminal distortion during side wiring. The height of internal standoffs 14a, 14b is critical for preventing terminal distortion. Terminal distortion is of particular concern in switches with a terminal which contains a contact. If terminal distortion occurs, this affects contact location, thus making the switch inoperable.

Outboard standoffs 20a, 20b have two functions. The first function is wire alignment/captivation in that the conductor wire is aligned by one of passageways 23 and 24 which are formed on one side by part of outboard standoffs 20a, 20b. The second function is to act in cooperation with internal standoffs 14a, 14b to prevent terminal post screw 18 from interfering with opposite terminals when screw 18 is fully tightened, as explained above. The height of outboard standoffs 20a, 20b is also important. Too large a height prevents adequate gripping during back wiring, while too small a height causes gripping problems during back wiring.

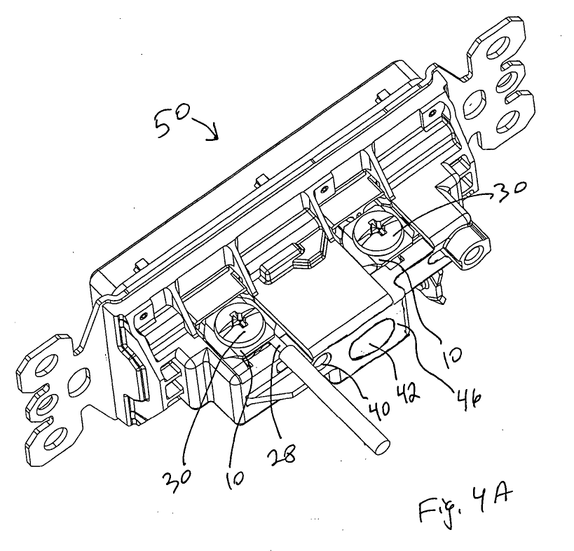

Referring to FIG. 3, a partial cross-sectional view of the electrical device shows wire 28 inserted into a speed wire hole 40, where wire 28 makes contact with a speed wire arm 44. Speed wire arm 44 is part of terminal 48, so that wire 28 makes electrical contact with terminal 48 via speed wire arm 44. A speed wire release hole 42 is shown inside a body 46. To remove wire 28, one inserts a screwdriver into speed wire release hole 42 to force speed wire arm 44 away from wire 28, at which time wire 28 is pulled from speed wire hole 40.

Anti-rotation leg 22 has two functions. The first function of leg 22 is to maintain the orientation of pressure plate 10 by fitting into an opposing hole or recess in the terminal itself. The second function of leg 22 is to limit the travel of speed wire arm 44 so that speed wire arm 44 is not permanently deformed when removing wire 28. This permanent deformation can render the speed wire or feature inoperable, i.e., the speed wire or arm fails to grip the wire upon a second wire insertion.

While the present invention has been described with reference to a particular preferred embodiment and the accompanying drawings, it will be understood by those skilled in the art that the invention is not limited to the preferred embodiment and that various modifications and the like could be made thereto without departing from the scope of the invention as defined in the following claims.

What is claimed is:

1. A pressure plate for an electrical device, comprising:
a flat portion, said flat portion having a hole centered therein;
a first internal standoff adjacent said hole;
an outboard standoff disposed at a first location on said flat portion; and
an anti-rotation leg disposed at a second location on said flat portion.
